(19) United States
(12) Patent Application Publication
(10) Pub. No.: US 2004/0247501 A1
(43) Pub. Date: Dec. 9, 2004

(54) Catalytic reactor and method

(76) Inventors: George Y. Adusei, Branchburg, NJ (US); Achim K. Heibel, Corning, NY (US)

Correspondence Address: CORNING INCORPORATED, SP-TI-3-1, CORNING, NY, 14831

(21) Appl. No.: 10/848,451

(22) Filed: May 17, 2004

Related U.S. Application Data
(63) Continuation-in-part of application No. 10/012,678, filed on Nov. 5, 2001.

(51) Int. Cl. B01J 8/02; B01J 35/02

(52) U.S. Cl. 422/211; 422/222

(57) ABSTRACT

A multiphase reactor device incorporating a stack of monolith catalysts comprising monolith slabs (spacers) between adjacent monolith blocks, the stack, preferably of larger channel diameters and higher void fractions than the monolith blocks, the spacers (i) reducing hydraulic restriction and channel blocking at the stacking interface, (ii) increasing the number of block interfaces for the disruption and mixing of the laminar film falling down the monolith wall and, (iii) for counter-current applications, raising the resistance of the stack to flooding to broaden the operating window or range of gas and liquid flow velocities operable in the reactor.

This application is a continuation-in-part of U.S. patent application Ser. No. 10/012,678, filed Nov. 5, 2001.

### BACKGROUND OF THE INVENTION

The present invention relates to catalytic reactor devices and methods for using them to process gas-liquid reactant streams. More particularly, the invention relates to a device, scheme or arrangement and method for improving the hydraulic efficiency, expanding the operating window and hence improving the performance of such reactors. The invention provides multiphase stacked-monolith reactors having a solid phase catalyst, and whose monoliths are staged and separated by spacers with specific geometric characteristics to improve the operating window of the reactors as well as overall reactor performance.

A monolith catalyst or catalyst support consists of a large number of narrow channels separated by thin walls. The channels have well defined geometry and the number of channels may range from 16 to 1600 cells per square inch (cpsi). Monolith supports of these configurations, also termed honeycombs or honeycomb monoliths or catalysts, are typically made out of metallic or, more commonly, ceramic materials. For reaction applications, a monolith substrate that is not itself catalytically active is usually coated with a layer of high surface area material on which active ingredients are dispersed. Monolith catalysts thus made have been used successfully in exhaust gas cleaning applications due to their high specific surface area and low pressure drop compared to alternatives such as packed beds.

Because of these desirable attributes, monolith catalysts have been receiving considerable attention in recent years for multiphase reactor applications. A multiphase reactor incorporates a catalyst on or within a solid support and is used for processing two-phase gas-liquid feed streams. A multiphase monolith reactor incorporating a monolithic support as the packing material is an efficient gas-liquid-solid phase contacting and reaction device.

Many factors influence the efficiency of such catalyst systems. Some of these factors include the overall reactor geometry, the operating conditions, and the geometry of the channels of the monolith packing, including the shapes and dimensions of the channels. Also important are channel wall thickness and cell density. Any number of these attributes can be manipulated to adapt the reactor to specific applications.

The maximum length of presently manufactured ceramic monolith blocks is typically about 500 mm, although in some cases the length can be 1000 mm or higher. Particularly in the case of ceramic catalyst supports or supports to which catalysts must be added by coating or impregnation methods, the monolith manufacturing process, the wash coating step that applies a high surface area carrier material to the monolith, and the impregnating process for applying a catalyst can each place practical limitations on the length of the monolith catalyst block. Thus a practical limit on catalyst block length for many purposes is typically in the range of 300 mm.

For these and other reasons, commercially practical multiphase monolith reactors will therefore necessarily require the stacking of any number of individual monolith blocks upon each other to achieve a desired reactor length. Two different stack approaches may be used. In a first method, monolith sections are stacked with their channels aligned such that channels in each monolith sections feed directly into corresponding channels above and below them. In this assembly technique, each resulting continuous channel can be treated as a single reactor.

A second stacking approach randomly stacks the monolith sections without regard to channel alignment between the different monolith sections. In this assembly, each channel in a monolith section may open to feed into multiple channels above and below it, and may be partially or fully blocked by the walls of the monolith above and below it.

In medium to large-scale installations, the second method preferred because the tolerances of the cell matrix and the difficulty associated with the arrangement of the monolith blocks. This random stacking can have negative as well as positive performance implications. It is well known that the liquid film flowing down the channel walls of the monolith is disrupted at monolith stacking points. This disruption at the stacking points introduces some mixing of the liquid phase, which can be beneficial to reactor performance due improved mass transfer. More detailed discussions can be found in Lebens, P. J. M., “Development and Design of a Monolith Reactor for Gas-Liquid Counter-current Operation,” Ph.D. thesis, T U Delft, 1999, and Brauer, H., Mewes, D., “Stoffaustausch Einschliesslich Chemischer Reaktion,” Sauerlander, Aarau, 1971.

However, stacking generally has a negative impact on the hydrodynamics and pressure drop. (see Reinecke, N., Mewes, D., “The Flow Regimes of Two-Phase Flow in Monolithic Catalysts,” Proc. 5 The World Congress of Chemical Engineering, Jul. 14-18,1996, San Diego, Calif., Vol. IV) and accelerates the approach to flooding in a counter-current flow reactor. Counter-current flow occurs when gas flows in one direction (i.e., up) as liquid flows in the opposite direction through the honeycomb channels. Random stacking also allows for some mixing between the different channels, and therefore has the potential to improve the uniformity of the flow distribution.

The present invention teaches a reactor device and method to reduce the negative effects of stacking while enhancing the positive effects on the performance of both co-current and counter-current flow applications. Moreover, and most importantly, the present invention reflects the discovery that the key to increasing reactor efficiency is to decouple geometric requirements (e.g., small channels, low void fractions) from hydraulic and channel blocking restrictions, while maintaining or even increasing benefits due to stacking.

In U.S. Pat. No. 6,206,349, issued to Parten on Mar. 27, 2001, entitled FLUID-FLUID CONTACTING APPARATUS, a device having a structured, corrugated packing is illustrated. The corrugations extend obliquely relative to the direction of the counter-current, gas-liquid flow. The oblique interface of this device produces very high pressure drops and liquid accumulation, which result in a non-uniform distribution in lower sections of the structure.

By contrast, the current invention teaches monolithic structures that have channels aligned with the flow direction, which creates uniformity in the flow distribution.

In European Patent No. EP 0 667 807 B1 published on Jul. 29,1998, entitled PROCESS FOR CATALYTICALLY REACTING A GAS AND A LIQUID, a process is illustrated for desulferizing oil using a catalyst. The walls of the channels of the reactor comprise both concave and convex portions for separating the gas phase from the liquid phase.

### SUMMARY OF THE INVENTION

In accordance with the present invention, there is provided a multiphase catalytic reactor device comprising stacked monoliths and a method for using such a device to improve the processing of two-phase gas-liquid feed streams. Monolith slabs (spacers) are placed in between every two monolith blocks in the stack of reactor monoliths. The spacers are of substantially the same cross-section but of larger channel diameters and thinner walls than the monolith blocks. Thus they have higher void fractions than the monolith blocks. As a result, hydraulic restriction and channel blocking at block intersections are reduced, resulting in improved fluid transfer between monolith sections and thus better catalyst utilization at the stacking interface.

The staged monoliths and spacers employed in the reactors of the invention can be constructed of catalytically active or inert material. The length of the small spacer sections is adjustable. In the extreme case, monolith sections and spacers of equivalent length can be stacked.

For small channels, it is often beneficial to apply the spacer as a stack of monolith slabs of increasing and then decreasing channel size or open frontal area, so that the change in flow pattern occurs in steps. This enables a chemical processing method allowing for a smooth transition between the large channels within the open spacer structure and the relatively small, adjacent channels of the monolith sections.

Owing to their inherent openness, triangular, square, and hexagonal channel structures are most commonly used as spacers. However, the channel shape of the top and bottom monoliths sandwiching each spacer can be designed to fit particular needs from a reactive perspective, such as high catalyst loading (low void fraction) and small channels (improved contacting).

Applying spacers improves the flooding performance of the monolith stack, and hence, broadens the operating window (i.e., the range of gas and liquid flow velocities that are possible) within the reactor, especially in counter-current flow operation. Flooding is a back transport of the liquid against its desired flow direction due to the interaction with the gas phase.

While spacers can be of some benefit in co-current gas-liquid processing applications, they are highly beneficial for countercurrent application, where the problem of flooding is of particular concern. Thus these spacers have been found to significantly raise the resistance of a monolith stack to flooding under countercurrent conditions, as hereinafter more fully described.

It is therefore a further important aspect of the invention to provide an improved method for treating a gas-liquid process stream. In accordance with conventional gas-liquid countercurrent processing, a honeycomb stack comprising multiple monolith blocks is provided, and, a liquid component is passed downwardly through the blocks while a gas for interacting with the liquid is passed upwardly therethrough. In accordance with the invention, however, the range of gas and liquid flow velocities through the stack is increased by positioning at least one monolith slab spacer between at least two adjacent monolith blocks in the stack.

In carrying out the process of the invention, the monolith spacers and adjacent monolith blocks will extend over the same reactor cross-section. It is important to observe this requirement in order to prevent horizontal as well as vertical gaps in the stacked monolith configuration which could increase the susceptibility of the monolith column to flooding.

In general, the spacers will have a larger channel diameters and higher void fractions than the adjacent monolith blocks, thereby reducing the incidence of liquid hold-up or flooding as the liquid passes from the two monolith blocks. In preferred embodiments, the spacer may itself comprise a stack of monolith slabs of increasing and then decreasing channel size or open frontal area, so that the change in flow pattern within the spacer and between monolith blocks occurs in steps.

### BRIEF DESCRIPTION OF THE DRAWINGS

A complete understanding of the present invention may be obtained by reference to the accompanying drawings, when considered in conjunction with the subsequent detailed description, in which:

FIG. 1 illustrates a schematic view of a stacked monolith of a reactor having an improved flow in the boundary layer;

FIGS. 2a and 2b depict a schematic view of a comparison between stacked monoliths using spacers; and

FIG. 3 shows a graph depicting the flooding performance of stacked monoliths with and without spacers.

### DETAILED DESCRIPTION

Generally speaking, the invention features a multiphase catalytic reactor device comprising stacked monoliths, and a method for utilizing such a reactor device to treat a gas-liquid process stream. Monolith slabs (spacers) are placed in between the monolith blocks in a stack of reactor monoliths. The slabs are of lower cell density than the monolith blocks, therefore typically having larger channel diameters and preferably higher void fractions. As a result, hydraulic restriction and channel blocking between the reactor monoliths are reduced, and therefore better catalyst utilization at the stacking interface is achieved.

For counter-current applications, the spacers improve the flooding performance of the monolith stack, and hence, the operating window (i.e., the range of gas and liquid flow velocities that is possible) for the reactor.

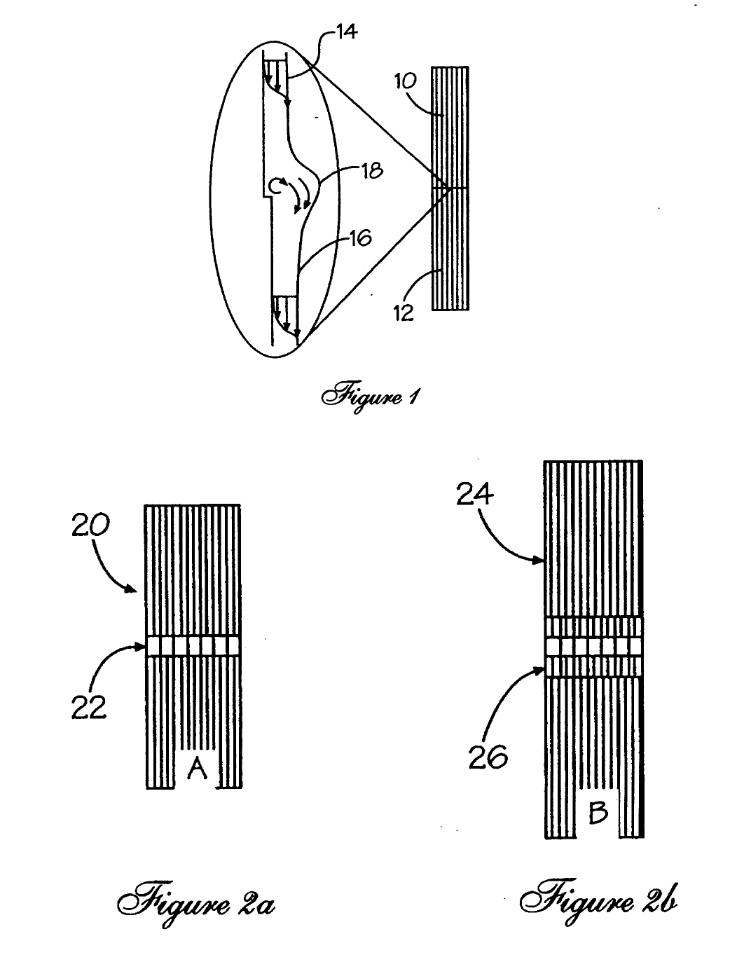

Now referring to FIG. 1, a schematic view of two stacked monoliths 10 and 12 is shown. The monoliths 10 and 12 have an interrupted flow 14 in the boundary layer 16. The laminar liquid film flow is disrupted at the stacking point 18, which causes mixing of the liquid at the stacking point 18. This mixing can improve mass-transfer, but it can also result in flooding .

Now referring to FIGS. 2a and 2b, the current invention places monolith slabs (spacers) 22, 26 in between every two monolith blocks 10, 12 (FIG. 1) in a stack of reactor monoliths. Such spacers 22, 26 present a higher monolith void fraction to downwardly flowing liquid transitioning from monolith members 20 and 24, respectively, and, in particular, provide larger channel openings than adjacent sections.

FIG. 2a depicts a monolith configuration 20 with a single spacer 22. FIG. 2b illustrates a stacked monolith 24 with stepped spacers 26. The present invention provides a means for enhancing the positive attributes of random stacking, while reducing the negative effect upon performance parameters in both co-current and counter-current flow applications. Especially for counter-current applications, the spacers 22, 26 improve the flooding performance of the monolith stack 20, 24, and hence, broaden the operating window of the reactor. Further, with the application of spacers, the number of interfaces is increased by at least one, creating transitions of the laminar liquid film to introduce additional mixing, which is beneficial for reactor performance.

The staged monoliths 24 and spacers 26 can be constructed of catalytically active or inert material. The length of the small spacer sections is adjustable. In the extreme case, equal lengths of monolith sections and spacers can be stacked. For small channels, it might be beneficial to apply spacer configurations wherein the change in channel diameter occurs in steps. This allows for a smooth transition between the large channels with their open spacer structure, and the relatively small, adjacent channels.

Owing to their inherent openness, triangular, square, and hexagonal channel structures are most commonly used as spacers. However, the channel shape of the top and bottom monoliths surrounding a spacer can be designed to fit particular needs of the application.

It is generally beneficial to avoid any gaps between blocks and spacers in the stack. Gaps can increase the pressure drop (especially at lower liquid loads), and might be detrimental to the flooding performance.

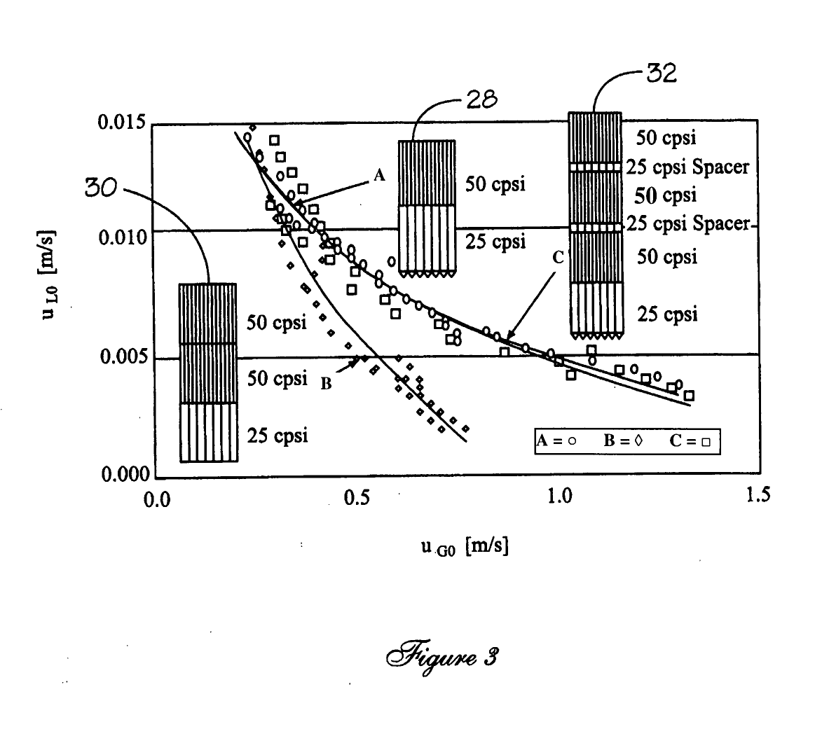

Now referring to FIG. 3, a graph demonstrates the benefit of applying spacers in a monolith stack. The graph illustrates that the spacers improve the flooding performance of the reactor.

To generate the data in FIG. 3, a liquid (n-decane) is distributed over the top of a monolith stack with a spray nozzle, and gas (air) is fed counter-currently upwardly through the monolith test section. The pressure drop is continuously monitored over the monolith section. Flooding is determined by an increase in pressure drop in the gas feed.

The curves in the graph indicate the flooding line. Above the line, the column is flooded; below the curve, non-flooded operation is possible. Curve “A” with the 25 cpsi outlet section and the 50 cpsi monolith 28 can be considered (black line and symbols) as the baseline.

Regular non-aligned stacking of an additional block 30 of 50 cpsi shifts the flooding limits to considerably lower values, especially for lower liquid velocities, as shown in curve “B”. In contrast, a stacked configuration 32 with spacer and even three 50 cpsi substrates stacked on top of each other results in the same performance as the baseline case, as shown in curve “C”. To ensure that this performance was not due to a special arrangement of the blocks, the experiment was repeated with a total reassembling of the column. The same performance was obtained.

The usage of spacers with preferably high open frontal area and large diameter channels to improve the hydrodynamic performance (i.e., flooding) in multiphase monolith reactors with randomly stacked monolith blocks is demonstrated from the above illustrated graphs. Openness of these spacer structures prevents blockage of channels of the stacked monoliths. This is especially important for low void fraction monolith structures (high catalyst load).

The change in channel diameter is preferably effected gradually by applying multiple spacers. The spacer sections are used to induce local redistribution to improve the flow uniformity over the monolith cross-section. The spacers may also be useful to disrupt the liquid film at the stacking border to introduce local mixing and therefore break up the laminar liquid film leading to better mass-transfer performance. The increased number of interfaces that result from applying the spacers has the positive effect of enhancing the mixing process.

Since other modifications and changes varied to fit particular operating requirements and environments will be apparent to those skilled in the art, the invention is not considered limited to the examples chosen for purposes of disclosure, and covers all changes and modifications which do not constitute departures from the true spirit and scope of this invention.

We claim:

1. A multiphase monolith reactor having randomly stacked monolith blocks, said stacked monolith blocks comprising spacers disposed there between to provide a higher monolith void fractions and larger diameter channels, whereby hydrodynamic, flooding performance is improved.

2. The multiphase monolith reactor in accordance with claim 1, wherein at least some of the spacers disposed between the monolith blocks are multiple spacers.

3. The multiphase monolith reactor in accordance with claim 1, wherein said spacers increase the number of interfaces of said reactor, enhancing mixing laminar film therein.

4. The multiphase monolith reactor in accordance with claim 1, wherein at least some of the spacers disposed between the monolith blocks are used as means to improve flow uniformity over the cross-section of said monolith blocks.

5. The multiphase monolith reactor in accordance with claim 1, wherein at a border of the stacked monolith blocks, at least some of the spacers disposed between the monolith blocks have means for multiple disruption of a liquid film flow at said border.

6. A reactor device comprising multiphase, stacked monolith blocks, said monolith blocks being spaced apart by spacers disposed between every two monolith blocks in a stack of stacked monolith blocks.

7. The multiphase monolith reactor in accordance with claim 6, wherein at least some of the spacers disposed between the monolith blocks are multiple spacers.

8. The multiphase monolith reactor in accordance with claim 6, wherein at least some of the spacers disposed between the monolith blocks are staged spacers.

9. The multiphase monolith reactor in accordance with claim 6, wherein said spacers increase the number of interfaces of said reactor, enhancing mixing laminar film therein.

10. The multiphase monolith reactor in accordance with claim 9, wherein at a border of the stacked monolith blocks, at least some of the spacers disposed between the monolith blocks have means for disruption of a liquid film flow at said border.

11. In the method for gas-liquid countercurrent processing wherein a honeycomb stack comprising multiple monolith blocks is provided and a liquid component is passed downwardly through the blocks while a gas component for interacting with the liquid is passed upwardly therethrough, the improvement wherein:
the range of gas and liquid flow velocities through the stack is increased by positioning at least one monolith slab spacer between at least two adjacent monolith blocks in the stack, the monolith slab spacer having a larger channel diameter and higher void fraction than the adjacent monolith blocks.

12. A method in accordance with claim 11 wherein the monolith slab spacer comprises a stack of monolith slabs of increasing and then decreasing channel size, whereby the change in flow pattern within the spacer and between monolith blocks occurs in steps.

13. A method in accordance with claim 11 wherein the stack of monolith blocks and monolith slab spacer is free of gaps between blocks and spacers.
